(19) United States
(12) Patent Application Publication
(10) Pub. No.: US 2021/0346859 A1
(43) Pub. Date: Nov. 11, 2021

(54) METHOD OF AND APPARATUS FOR PRODUCING MATERIALS

(71) Applicant: NPL MANAGEMENT LIMITED, Teddington, Middlesex (GB)

(72) Inventors: Mark HODNETT, Teddington (GB); Piers TURNER, Teddington (GB)

(21) Appl. No.: 17/261,295

(22) PCT Filed: Jul. 23, 2019
(86) PCT No.: PCT/GB2019/052057

§ 371 Date: Jan. 19, 2021

(30) Foreign Application Priority Data
Jul. 24, 2018 (GB) 1812056.8

(51) Int. Cl. B01J 19/00; C01B 32/192

(52) U.S. Cl. CPC B01J 19/008; B01J 19/10; C01B 2204/32; C01B 32/192

(57) ABSTRACT

A method and apparatus produce materials by exfoliation from a bulk material, by disposing bulk material in suspension in a liquid in a chamber; applying superimposed ultrasound fields in the chamber, the superimposed ultrasound fields generating cavitation in the liquid at least at a zone of field superimposition; measuring cavitation in the chamber while applying the superimposed cavitation fields, at least at the zone of field superimposition; and adjusting at least one of the ultrasound fields on the basis of measured cavitation so as to control cavitation energy applied to the material and thereby to control exfoliation of the bulk material and the formation of materials therefrom. Inertial cavitation is controlled, resulting in significantly greater production yields compared to prior art systems and methods. A high intensity focused ultrasound transducer is provided to impart suspension energy to the liquid in the chamber for suspending bulk material in the zone of field superimposition.

### FIELD OF THE INVENTION

The present invention is directed to a method and apparatus for producing materials, such as laminar products, from bulk material. The invention is particularly suitable for the production of graphene from graphite but may also be used for the production of any other materials from a bulk, whether crystalline or amorphous. Some of the materials could be classified as nanomaterials.

### BACKGROUND OF THE INVENTION

Ultrasonication is widely used to exfoliate two-dimensional layered materials such as graphene, exfoliated from graphite. The fundamental mechanism of ultrasonication is poorly understood and often neglected, resulting in very low exfoliation rates, low material yields and wide size distributions, making graphene dispersions produced by ultrasonication less economically viable.

Since the discovery of graphene and the characterisation of its properties, it has shown a huge potential in applications ranging from energy storage, solar cells, printed electronics, composite filters and dyes including, recently, hair dye. Graphene has excellent electrical and thermal conductive properties, as well as high elasticity, and is virtually impermeable to all molecules. As a result, graphene shows significant potential for high speed electronics, optic circuits, photovoltaic cells, biosensors and sophisticated catalysing and filtering solutions for the chemical industry.

The discovery of graphene has also generated significant research interest into other two-dimensional layered materials such as the family of metallic and semi conductive transition metal di-chalcogenides.

However, one of the main challenges limiting the further application and commercialisation of graphene and other two-dimensional layered materials is that they remain difficult to produce in large quantities of high quality flakes with well controlled size distribution. Many of the useful properties of graphene are dependent on the lateral size and thickness of individual flakes. For instance, graphene flakes with large lateral dimensions (that is greater than 1 μm) are used in polymer composites and conductive graphene inks. Flakes with smaller lateral dimensions (that is less than 1 μm) are employed in ceramic composites. Graphene quantum dots (less than 100 nm) are found in photovoltaic, fuel cells and catalysis applications.

One of the most scalable dispersed graphene production roots is liquid phase exfoliation from graphite using ultrasonication, shear mixing or micro-fluidization. These production methods are, however, generally characterised by dispersions with wide flake distributions (typically from nm to μm) and also low yields, typically between 1 to 5%. As a consequence of the low yields, large exfoliated graphite flakes are often present in the graphene dispersions post sonication. Extensive, energy-intensive centrifugation is required to remove them and extract the graphene. Although cascade centrifugation has been shown to be effective in isolating narrow size distributions, it is time intensive, lowers the bulk concentration of the dispersed graphene and can inadvertently remove graphene flakes with larger lateral dimensions. As liquid phase exfoliation techniques typically produce dispersions with low intrinsic graphene concentrations (around 0.1 mg per ml) centrifugation and re-dispersion is often required to produce graphene dispersions with industrially viable concentrations, that is of around or greater than 1 mg per ml. As such, removal of large graphene flakes can be unavoidable when producing graphene dispersions.

Despite micro-fluidization and shear mixing demonstrating superior graphene exfoliation rates, ultrasonication is one of the most widely used methods to produce high quality graphene dispersions due to the abundance of sonic baths. The art has, however, found it difficult to control the process of exfoliation and relies primarily on purely empirical parameters such as sonication time, temperature calorimetry and nominal electrical input power to monitor and develop the ultrasonication process.

### SUMMARY OF THE PRESENT INVENTION

The present invention seeks to provide a method and apparatus for producing materials by exfoliation of a bulk material, typically a layered bulk material in which the layers are coupled together by relatively weak van der Waals forces.

According to an aspect of the present invention, there is provided a method of producing materials by exfoliation from a bulk material, including the steps of: disposing bulk material in suspension in a liquid in a chamber; applying superimposed ultrasound fields in the chamber, the superimposed ultrasound fields generating cavitation in the liquid at least at a zone of field superimposition; measuring cavitation in the chamber while applying the superimposed cavitation fields, at least at the zone of field superimposition; adjusting at least one of the ultrasound fields on the basis of measured cavitation so as to control cavitation energy applied to the material and thereby to control exfoliation of the bulk material and the formation of materials therefrom.

The step of adjusting at least one of the ultrasound fields preferably adjusts one or more of: acoustic pressure, time of application of the field or fields, ultrasound frequency and ultrasound amplitude distribution.

The preferred embodiments measure and control inertial cavitation in the liquid.

The taught method provides an efficient mechanism for transferring energy, particularly inertial or instantaneous cavitation energy to the bulk material and exfoliation thereof. Much higher yields of materials are possible compared to prior art systems, particularly when coupled to the other advantageous characteristics disclosed herein.

The preferred embodiments also include the step of controlling temperature of the liquid in the chamber during application of the superimposed ultrasound fields. In some embodiments this may be by use of cooling fans. In other embodiments this may be by shorter sonication times or by using burst mode ultrasound.

Advantageously, the method includes the step of circulating the liquid in the chamber during the application of the ultrasound fields.

The method may include the step of applying suspension energy to the liquid in the chamber for suspending bulk material in the zone of field superimposition. This may be achieved by applying high intensity focused ultrasound to the chamber, said high intensity focused ultrasound imparting suspension energy to the liquid in the chamber for suspending bulk material in the zone of field superimposition. Advantageously, the high energy focused ultrasound is applied in a central zone of the chamber, allowing for toroidal movement of the suspension liquid in the chamber.

The superimposed ultrasound fields are advantageously produced by a plurality of transducers disposed so as to face into the chamber. In the preferred embodiment, the superimposed ultrasound fields are produced by a plurality of transducers disposed in an annular arrangement so as to face into the chamber. The chamber is advantageously cylindrical, such that a cylindrical zone of superimposed ultrasonic energy is created in the liquid, preferably of balanced energy.

The ultrasonic fields are preferably at a common frequency, phase, and/or amplitude but in some embodiments they may be at different frequencies, phases and/or amplitudes.

In the preferred embodiments, the method includes the step of measuring cavitation by means of a detector of a type previously disclosed by the applicant, for example in GB-2,358,705, WO-2009/016355 or EP-2,378,975.

The method may be used to produce a wide variety of materials, for example laminar elements from bulk material. It is particularly suitable for the production of graphene from graphite bulk material. In other examples, the method and apparatus disclosed herein can be used to process (exfoliate, fragment, crystallise, homogenise, react) many materials (such as polymers, particles, crystals, flakes, proteins, food etc.) in the liquid phase, and from industries varying from food production (100's of micrometres) to biofilm control (10's of nanometres), pharma API's and even DNA shearing. Some of these materials could be described as nanomaterials or micromaterials. It is to be understood that the method and apparatus disclosed herein can therefore be used for the production of nanomaterials, such as laminar products, but are equally applicable to producing materials other than nanomaterials or micromaterials.

It will be appreciated that a surfactant may be provided in the liquid to assist in the formation and retention of the nanoparticles.

According to another aspect of the present invention, there is provided apparatus for producing material products by exfoliation from a bulk material, including: a chamber for holding bulk material in suspension in a liquid; an ultrasound generator unit including a plurality of ultrasound sources arranged around the chamber and operable to apply ultrasound fields in the chamber, said ultrasound fields being superimposed in a zone of field superimposition in the chamber; a cavitation detector arranged to measure cavitation at least in the zone of field superimposition; and a control unit coupled to the ultrasound generator and to the cavitation detector, and configured to adjust at least one of the ultrasound fields on the basis of measured cavitation so as to control cavitation energy applied to the material, thereby to control exfoliation of the bulk material and the formation of materials therefrom.

Preferably, the control unit is configured to adjust one or more of: acoustic pressure, time of application of the field or fields, ultrasound frequency and ultrasound amplitude distribution.

The cavitation detector is advantageously configured to measure inertial cavitation.

The apparatus preferably includes a temperature control device for controlling temperature of the liquid in the chamber.

There may be provided a fluid circulation element operable to circulate liquid in the chamber during the application of the ultrasound fields.

Advantageously, the apparatus includes a fluid suspension device configured to apply suspension energy to the liquid in the chamber for suspending bulk material in the zone of field superimposition. This may be in the form of a high intensity focused ultrasound generator configured to apply high intensity focused ultrasound in the chamber, which imparts suspension energy to liquid in the chamber. In an embodiment, the high intensity focused ultrasound generator extends over a part of a lateral dimension of the chamber, so as to apply high intensity focused ultrasound in a central zone of the chamber, allowing for toroidal movement of the suspension liquid in the chamber.

Preferably, the ultrasound sources are transducers disposed facing into the chamber. The ultrasound field generation means may be an annular arrangement of transducers disposed facing into the chamber.

In many embodiments, the chamber is at least partially cylindrical.

According to another aspect of the present invention, there is provided apparatus for producing material products by exfoliation from a bulk material, including: a chamber for holding bulk material in suspension in a liquid; an ultrasound generator unit including a plurality of ultrasound sources arranged around the chamber and operable to apply ultrasound fields in the chamber, said ultrasound fields being superimposed in a zone of field superimposition in the chamber; a high intensity focused ultrasound generator configured to apply high intensity focused ultrasound in the chamber so as to impart suspension energy to liquid in the chamber for suspending bulk material in the zone of field superimposition; whereby the ultrasound fields are operable to generate cavitation energy at least in the zone of field superimposition thereby to subject bulk material to exfoliation for the formation of materials therefrom.

Other aspects and features of the teachings herein will become apparent to the skilled person from the specific description that follows.

### BRIEF DESCRIPTION OF THE DRAWINGS

Embodiments of the present invention are described below, by way of example only, with reference to the accompanying drawings, in which:

FIG. 1 shows the principles underlying the generation of cavitation in a liquid;

FIG. 2 is a graph depicting the distinctions between stable and inertial cavitation;

FIG. 3 is a graph depicting the production of graphene within a cavitation chamber;

FIG. 4 is a schematic diagram of a preferred embodiment of cavitation chamber;

FIGS. 5 and 6 are schematic diagrams of the chamber of FIG. 4, depicting the energy peak and levitation energy produced by the transducers of the apparatus;

FIG. 7 is a schematic diagram of the chamber of FIG. 4, depicting the energy peak and levitation energy produced by the transducers of the apparatus, with a secondary chamber;

FIG. 8 is a schematic diagram of the principal components of an embodiment of apparatus according to the teachings herein;

FIG. 9 is a graph of graphene yield against inertial cavitation dose;

FIG. 10 is a graph of graphene yield against the square root of the inertial cavitation dose;

FIG. 11 is a graph showing HF broadband energy as function of sonication time representative of the performance obtainable by the use of low density polyethylene (LDPE) or polypropylene (PP) elements forming the chamber;

FIG. 12 shows the graphene yields for different container types;

FIGS. 13 and 14 are graphs showing, respectively, the length and thickness distribution of graphene flakes by the described method; and

FIGS. 15a to 15f are graphs relating to the production of graphene achieved by an example process and system as described below.

### DESCRIPTION OF THE PREFERRED EMBODIMENTS

While ultrasonication has been widely used to exfoliate two-dimensional (2D) van der Waals layered materials such as graphene, its fundamental mechanism, inertial cavitation, has been poorly understood and often neglected in ultrasonication strategies. This has resulted in low exfoliation rates, low material yields and wide size distributions, making graphene dispersions produced by ultrasonication less economically viable. The method and apparatus disclosed herein enables much higher few-layer graphene yields, up to 18%, achieved by optimising inertial cavitation during ultrasonication. The inventors have discovered that the yield and the graphene flake dimensions exhibit a power law relationship with inertial cavitation dose. Furthermore, inertial cavitation has been shown to exfoliate preferentially larger graphene flakes, which causes the exfoliation rate to decrease as a function of sonication time. Effective measurement and control of inertial cavitation can optimise the high yield sonication-assisted liquid phase exfoliation of size-selected 2D van der Waals nanomaterials.

The method and apparatus taught herein can provide for control of the size distribution of flakes produced during exfoliation, allowing batches of material to be tailored to specific size requirements for a subsequent usage of the graphene.

The preferred method uses controlled ultrasound waves (for example tight regulation of frequency, amplitude) to create acoustic cavitation (sound-activated bubbles) which then interact with initial raw materials such as graphite, in solution, and in the presence of surfactant, to modify their particle size/thickness, resulting in products such as graphene.

There is also disclosed a reactor design which generates ultrasound in fluids (in batch or flow environments) at one or more specific spatial locations so as to deliver cavitation energy to the bulk material, preferably while maintaining temperature, and using in situ one or more cavitation detectors to monitor the cavitation energy and dose, as well as providing an active feedback loop to modulate the acoustic conditions. The selectivity and control of acoustic conditions generates cavitation of different types (inertial and non-inertial), which enables the dimensions and structure of the resulting materials to be controlled.

The apparatus may additionally include one or more separate ultrasound sources configured to cause levitation of the bulk and processed material, maintaining it within regions of preferential cavitation in the reactor.

The preferred embodiments:

a) can allow control over the dimensions of the resulting products;

b) can provide real-time monitoring of the physical process (cavitation) that drives material size modification and exfoliation;

c) can provide a feedback mechanism to modulate the applied cavitation stimulus to the fluid system, maintaining resulting product quality and consistency; producing higher yields of products than comparable methods such as shear mixing.

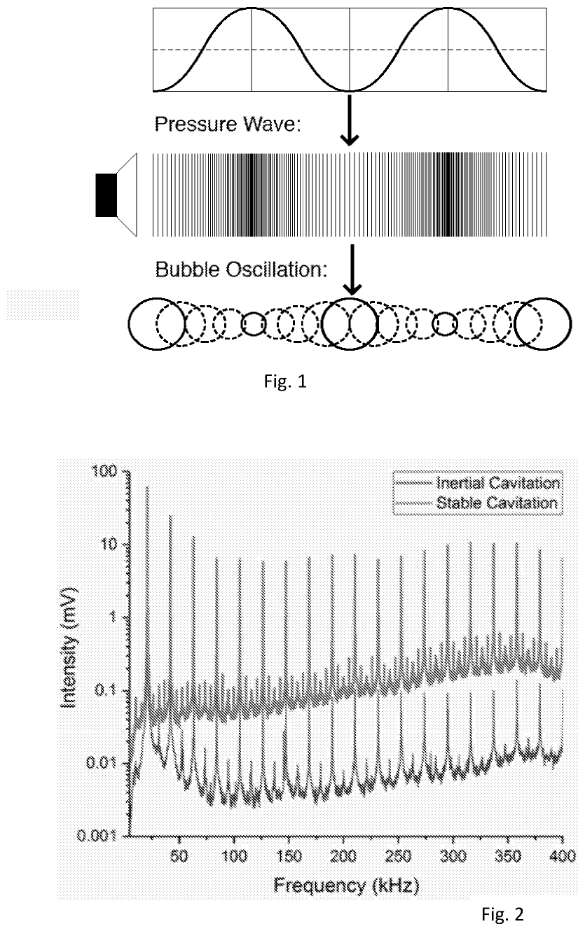

By way of explanation, acoustic cavitation is the stimulated expansion and collapse of microbubbles in response to an applied acoustic field, as depicted in FIG. 1. Sonic baths and sonic horns generate acoustic cavitation by exciting a fluid with continuous or pulsed pressure waves at kHz frequencies. As is known in the art, a regime with cavitating bubbles that have long lifetimes is referred to as stable cavitation, whereas inertial cavitation is characterised by short lived cavitating bubbles that undergo violent and chaotic collapse. Both types of cavitation are known to exhibit physicochemical effects that are strongly dependent on the properties of the liquid being sonicated (acoustic impedance and nucleation sites) as well as the acoustic field frequency, amplitude and geometry. Stable cavitation generates short range vortices known as microstreaming, whereas inertial cavitation collapses radiate spherical shockwaves with velocities of up to 4,000 m/s with peak pressures of up to 6 GPa. Intense liquid jets (jetting) with pressures of up to 1 GPa can also be generated during inertial collapse. In a typical sonication environment, such as a sonic bath or sonotrode, both types of cavitation can exist simultaneously.

FIG. 2 is a graph showing the frequency spectrum of cavitation signals arising from stable and inertial cavitation. The presence of harmonic activity is indicative of stable cavitation activity and the rise in the background noise is indicative of inertial cavitation activity. More specifically, the acoustic signals that cavitating bubbles emit can be measured using a calibrated needle hydrophone. Inertial cavitation is delineated from stable cavitation by quantifying the broadband noise, over a MHz frequency range, in which harmonic activity is not distinguishable from background noise. This can be carried out by measuring the high frequency broadband energy (equation 1), parametrised as E_{cav}, namely:

$${E}_{cav} = \frac{1}{N} {\sum }_{t = 1}^{N} {\int }_{{f}_{1}}^{{f}_{2}} {{V}_{c} ( f )}^{2} df \qquad ( 1 )$$

where V_{c}(f) are the spectral magnitudes measured from the frequency domain cavitation spectra (FIG. 2) and f₁ and f₂ are 1.5 MHz and 2.5 MHz respectively. The inertial cavitation threshold can be determined by measuring E_{cav} as a function of the nominal input power into the chamber.

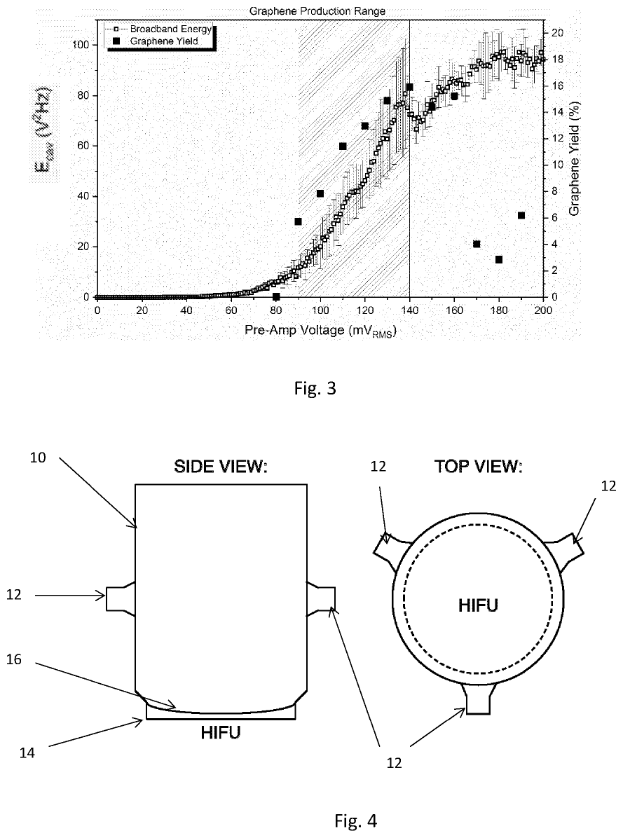

FIG. 3 is a graph depicting cavitation energy (E_{cav}), which is indicative of inertial cavitation activity, and graphene yield as a function of the output voltage of a signal generator used to drive a row of 21.06 kHz transducers via a 400 W power amplifier. The hashed rectangle in FIG. 3 represents the voltage range over which graphene was produced in this example.

As can be seen in FIG. 3, the inertial cavitation threshold is characterised by a systematic rise in E_{cav}. This occurs above a pre-amp voltage of ˜60 mV_{RMS}, which corresponds to a nominal input electrical power of 5 Watts (corresponding to a vessel power density of around 0.3 W/L).

It has been found that graphene is first produced only after the onset of the inertial cavitation (FIG. 2), which demonstrates that the physiochemical effects of inertial cavitation drive graphene exfoliation during ultrasonication. At high pre-amp voltages (high acoustic powers) E_{cav} saturates due to cavitation shielding, where a significant volume fraction of cavitating bubbles dynamically scatter and absorb the acoustic field. This can considerably affect the graphene exfoliation rates, such that a sharp reduction in the graphene yield occurs when E_{cav} saturates, as can be seen in FIG. 3. The highly non-linear nature of inertial cavitation combined with the significant perturbation of the graphene exfoliation rate at high acoustic powers can be managed by the measurement and control of inertial cavitation.

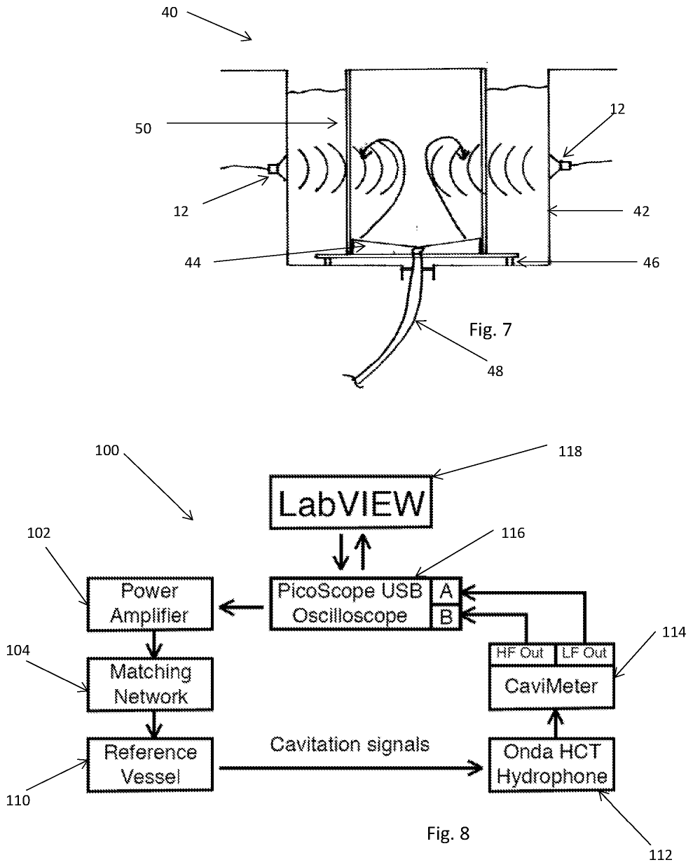

With reference now to FIG. 4, this shows in schematic form a side elevational view and a top plan view of the principal components of a preferred sonication chamber for the production of graphene from bulk graphite, although the apparatus could be used for the generation of any other materials including nanomaterials and micromaterials. The skilled person will appreciate that FIG. 4 is schematic only and that the apparatus will include other components typically associated therewith and which would be apparent to the skilled person, particularly having regard to the structural diagram of the system in FIG. 7.

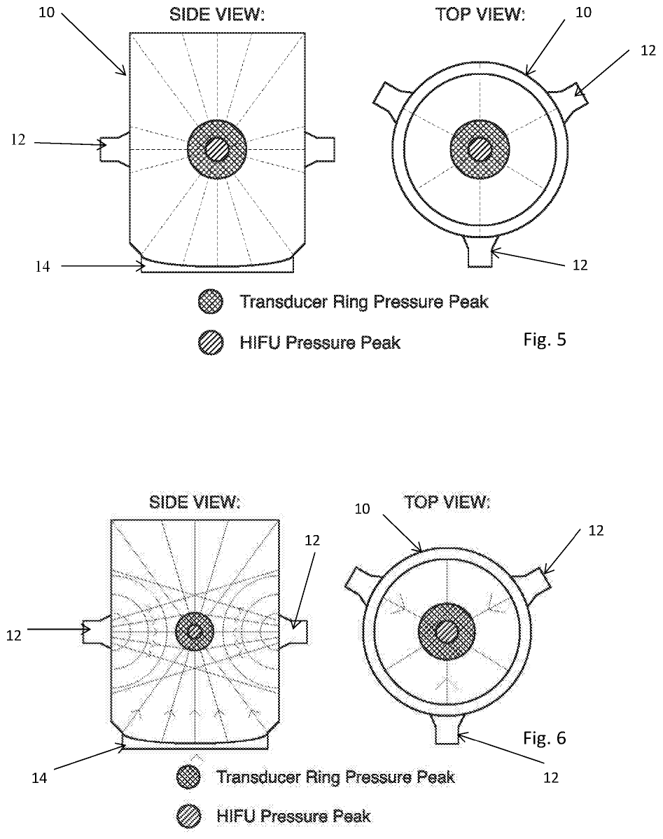

With reference to FIG. 4, this shows an embodiment of chamber 10, which in this example is generally cylindrical and round in axial cross-section, as will be apparent from the top plan view. In this particular example, the chamber 10 is shown as a receptacle with an open or openable top. Disposed around the outside of the wall forming the chamber 10 is a series of transducers 12 operable to generate excitation frequencies in the kilohertz range, as described in detail herein. In the example shown, there are three transducers 12 disposed circumferentially round the outside of the chamber 10 and spaced equally around the circumference of the chamber. The transducers 12 are all disposed at the same or a similar height, in what could be described as an annular or ring formation. As a result, the transducers 12 all point towards the centre of the chamber 10 and in use such that the ultrasonic energies produced by the transducers 12 overlap at a central zone of superimposition of the generated fields. This can be seen with reference to FIGS. 5 and 6 and described in further detail below.

The embodiment of apparatus shown in FIG. 4 also includes a high intensity focused ultrasound (HIFU) generator 14 disposed at a bottom or base surface 16 of the chamber 10. The HIFU generator is designed in practice to generate a suspension force with a centre of focus at or proximate the height of the transducers 12, such that the pressure or energy peak produced by the transducer ring of the transducers 12 and the pressure peak of the HIFU generator coincide. This has the effect of concentrating exfoliation energy at a zone, in this example in the central region, of the chamber 10 and also to levitate the bulk material into this zone of peak pressure or energy.

FIG. 7 shows in schematic form another embodiment of apparatus 40 having many similarities with the embodiments of FIGS. 4 to 6. The apparatus includes a chamber 42 of generally round cylindrical form (or other form as disclosed herein), within which is located a high intensity focused ultrasound (HIFU) transducer 44, disposed on a transducer mount 46 and coupled to a supply cable 48 through an aperture in the base of the chamber 42. A series of acoustic transducers 12 (preferably three or more), of the same nature as described in the present application, is disposed in annular arrangement around the outside of the chamber wall 42.

Located within the chamber 42 is a secondary chamber 50 disposed around the HIFU transducer 44 and which in practice confines the bulk material to be treated into a smaller volume, thereby concentrating the graphite in a region of intense and localised inertial cavitation.

As described in further detail below, it is preferred that the material of the chamber wall 42 and of the or any secondary chamber 50 be made of a plastic material or other minimally perturbing material. Low density polyethylene (LDPE) and polypropylene (PP) are particularly suitable.

The skilled person will appreciate that in embodiments of the invention there may be provided more than three transducer elements within the “ring” and some embodiments that may be provided only two transducer elements. Similarly in some embodiments there may be provided more than one “ring” of transducer elements, disposed at different heights along the cylindrical wall of the chamber 10, so as to create different zones of peak energy/pressure intensity. In such an embodiment, the different “rings” of transducer elements 12 may be operated at the same or at different frequencies for imparting different exfoliation energies to the bulk or laminar material produced by earlier exfoliation.

It is preferred that the chamber is circular in axial cross-section but in other embodiments the chamber may have a different axial cross-sectional shape. For instance, the chamber may be square or have any other polygonal shape, for instance being pentagonal, hexagonal, octagonal, and so on. More specifically, using a chamber with a circular cylindrical geometry and transducers disposed therearound it is possible to generate very distinct regions of cavitation, which can then be quantified with the spatially sensitive ultrasound sensor, so as to localise/focus the graphene/graphite within that or those regions. A graphene reactor or chamber that is cylindrical functions as a resonator, whose modes of resonance are excited by the ring(s) of transducers. A cylindrical chamber or reactor is therefore seen as optimal.

A non-cylindrical reactor may be less efficient and produce less well-defined regions of cavitation. However, there are advantages in using other cross-sectional shapes. For example, prime numbers of transducers eliminate certain constructional modes, which can be advantageous in the controllability of cavitation.

Not shown in the Figures but optionally provided is a central reflector or secondary transducer (of high or low frequency) disposed on-axis within the reactor, which can remove the sharp on-axis peak and can provide a more homogeneous distribution.

With reference now to FIG. 8, this shows a schematic diagram of an embodiment of system for generating controlled cavitation and controlled exfoliation, and more generally for the generation of particles from bulk material.

The system 100 includes a power amplifier 102, a frequency matching network 104, a plurality of transducers coupled to the walls of reference vessel 110, which may be as per the chamber 10 of FIGS. 4 to 6 or chamber 40 as per FIG. 7. Cavitation within the vessel 110 is detected by a hydrophone 112 and forwarded to a cavitation meter (CaviMeter) 114. In this example, the output of the cavitation meter is paired to an oscilloscope 116 for display on a suitable platform, such as LabVIEW™ 118. In a commercial system, the oscilloscope would be replaced by a control unit configured to control the power amplifier 102 and therethrough the cavitation energy applied into the liquid in the reference vessel 110, as described in further detail herein.

In a practical example, acoustic cavitation measurements from the reference vessel 110 were carried out using an Onda HCT 0310 Needle hydrophone 112. An NPL Cavimeter™ cavitation meter 114 was used for hardware filtering and amplification of a low frequency (kHz) channel and high frequency (MHz) channel. The low frequency (LF) and high frequency (HF) channels were interrogated using a two channel Picoscope 5242B USB oscilloscope 116, which measured the time domain cavitation signals from the LF and HF channels simultaneously using a 15 bit vertical resolution and 0.1 kHz frequency resolution. LabVIEW software in a display and control unit 118 both drove the multi-frequency reference vessel, via the output channel of the Picoscope, and processed live cavitation signals measured by the Picoscope 116. Cavitation measurements were made by pulsing the signal generator output of the Picoscope. The pulse duration was four seconds and the dwell time was eight seconds. The pulsed mode operation minimised temperature build up and allowed large bubbles to dissipate between measurements such that cavitation hysteresis was mitigated.

The forty or so waveforms collected during each four second measurement were fast Fourier transformed and averaged before a full range of spectral measurements was performed. To ensure the acoustic cavitation measurements were representative of the cavitation fields that the graphene samples would be subjected to, the acoustic field measurements were performed with the HCT needle hydrophone positioned within an LDPE vessel acting as the chamber. The reference vessel was refilled between measurements with de-ionised and filtered water that was mixed with 0.2% by volume of MICRO-90 Cole Palmer surfactant. To evaluate the role of inertial cavitation on the liquid phase exfoliation of graphene, graphite with a narrow 45-75 μm size distribution was exfoliated over a range of both pre-amp voltages (shown in FIG. 2) and sonication times. As E_{cav} is a direct and real time measurement of the inertial cavitation activity, which is the stimulus driving the liquid phase exfoliation of graphene, multiplying E_{cav} by the total sonication time, t, quantifies the accumulated dose of inertial cavitation, (ICD), experienced by the graphite and graphene flakes during sonication. As the value of E_{cav}, and therefore ICD is dependent on the waveform capture settings (vertical resolution, timebase and sampling rate), the MHz frequency band over which it is calculated, the frequency response of the hydrophone, and the hardware filtering and amplification in the signal chain, absolute values obtained are arbitrary, though the units of ICD can be considered as volts squared. As the E_{cav} measurements in this example were carried out using the same measurement protocol, the resultant ICD measurements are directly comparable.

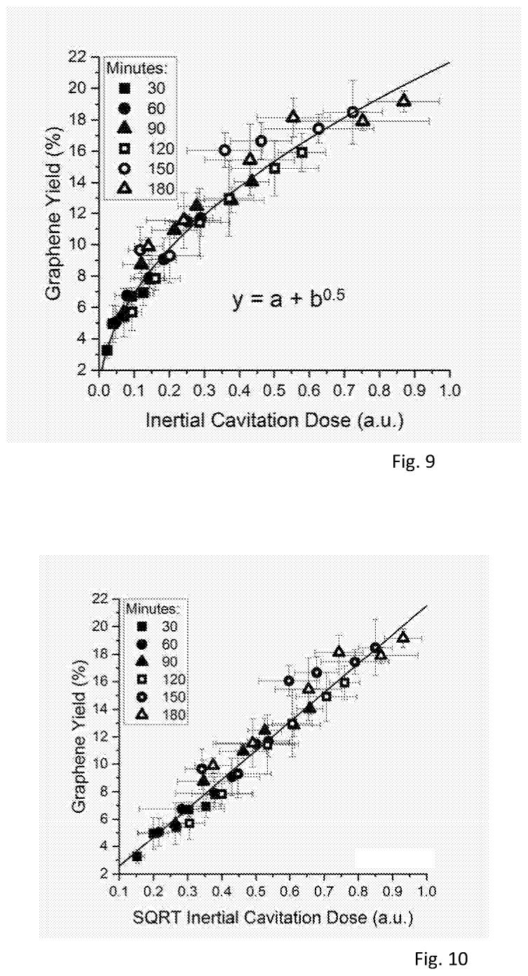

FIG. 9 shows that the graphene yield has a power law relationship with ICD, such that there is a linear relationship between graphene yield and the square root of the ICD (FIG. 10). As the ICD is a product of E_{cav} and sonication time, this square root relationship confirms the observation of graphene yield increasing as a function of the square root of sonication time. The graphene yield, given by ((c_{g}/c_{gi})*100), where c_{g} is the graphene concentration and c_{gi} is the graphite concentration, can thus be further enhanced by either increasing the inertial cavitation intensity or the sonication time. The highest graphene yield measured was about 18%, which is notably higher than accomplished in prior art systems.

Temperature build up during sonication can affect graphene exfoliation rate. It is therefore preferred that stable temperatures are maintained over long (150 and 180 minute) sonication times, for example by using an array of cooling fans to actively cool the vessel, in order to optimise consistent yields. Shorter sonication times as well as burst mode ultrasound may also additionally or alternatively be used to mitigate temperature increase during sonication.

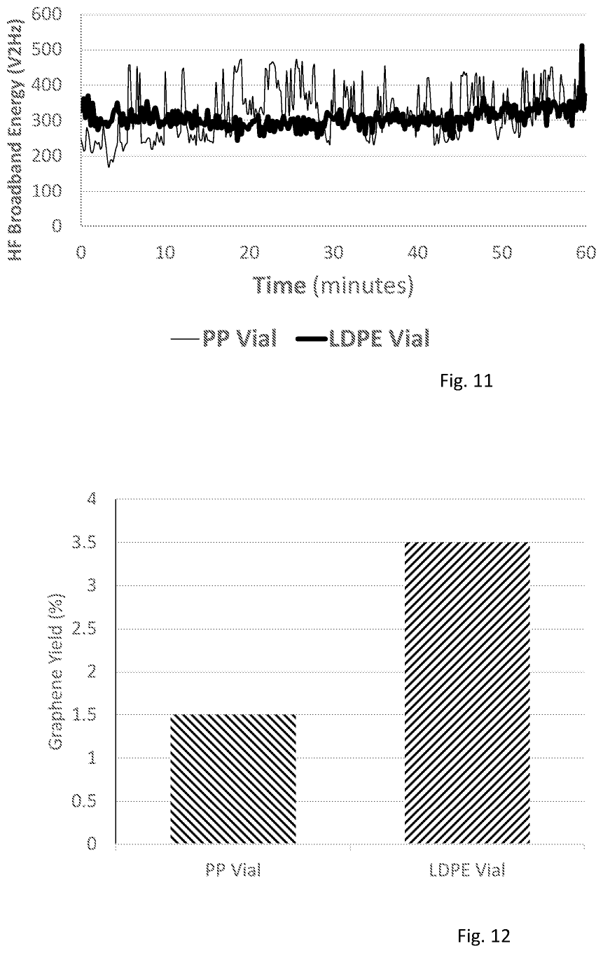

The choice of chamber wall material (and/or of any internal secondary chamber as per the example of FIG. 7) can have a bearing on the quality of ultrasonication and cavitation produced within the carrier liquid. For this purpose, a comparison was made between 15 ml polypropylene, PP, Fisherbrand centrifugation tubes and 28 ml Low Density Polyethylene, LDPE, Nalgene containers (both purchased from Fisher Scientific) to assess which chamber material may produce the highest graphene yields. It was found that the LDPE had a more consistent HF broadband energy as function of sonication time (FIG. 11), and produced higher graphene yields with the same processing parameters (FIG. 12). As LDPE has an acoustic impedance that is more closely matched to water than polypropylene (PP), this is likely to have a positive effect on the graphene yield due to a decreased perturbation of the acoustic field by the LDPE; water, LDPE and PP have an acoustic impedances of 1.48, 1.79 and 2.4 MRayls, respectively.

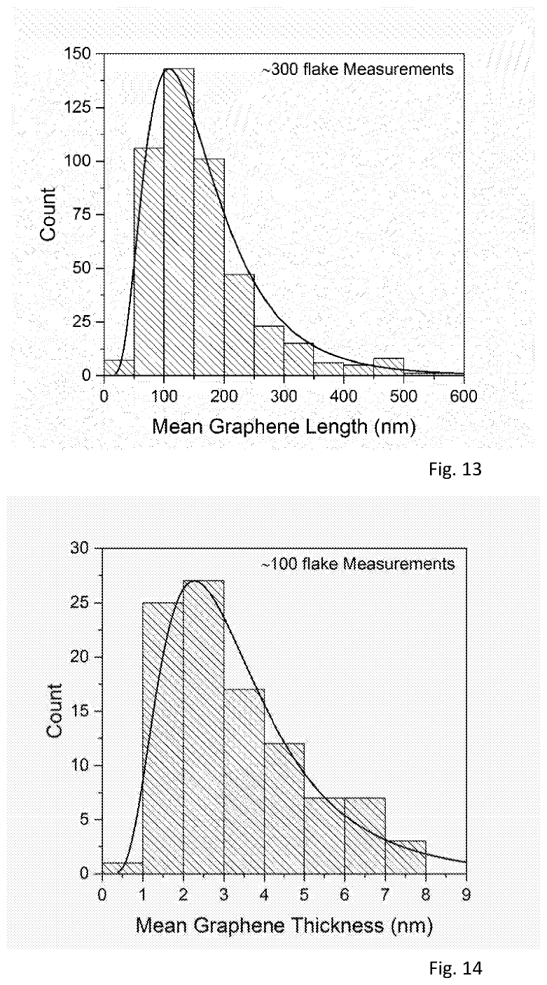

To quantitatively investigate the evolution of the graphene size distribution as a function of ICD, the lengths and thicknesses of graphene flakes were measured using scanning electron microscopy (SEM) and atomic force microscopy (AFM). The graphene length (FIG. 13) and thickness (FIG. 14) distributions were log-normal in shape, implying a multiplicative stochastic fracturing mechanism, whereas a bimodal distribution would be indicative of an erosion process. Accordingly, it can be concluded that inertial cavitation, which is characterised by stochastic and energetic bubble collapse, fractures graphite/graphene during sonication in a stochastic multiplicative process.

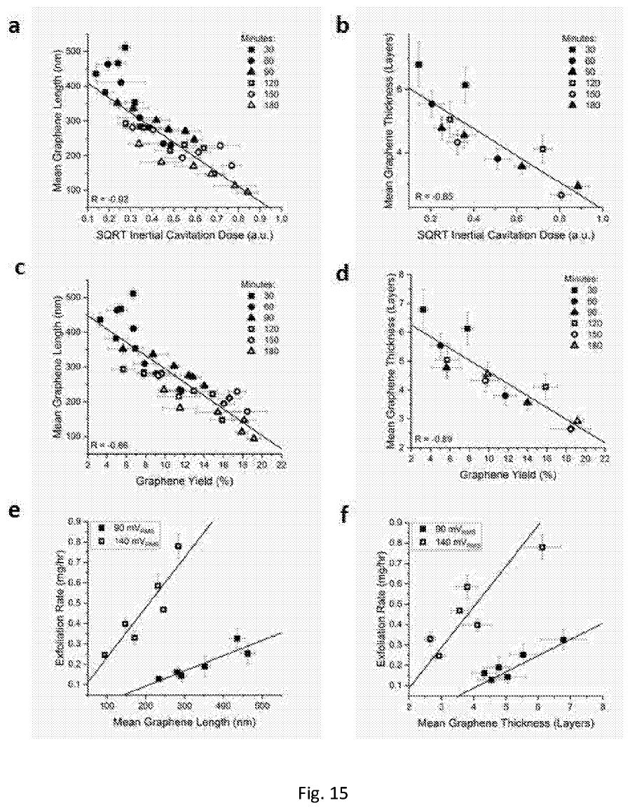

FIGS. 15a and 15b show that the mean length and thickness of graphene flakes decreases as a function of the square root of the ICD. As the <1 μm lateral dimensions of the flakes in post-sonication precipitate are significantly smaller than the dimensions of the initial graphite population (45-75 μm), this indicates that the initial graphite population has been fractured by the accumulated inertial cavitation activity during sonication. During sonication, the mean flake size will progressively decrease until the flakes are small enough to be suspended in the solution by the electrostatic repulsion of the adsorbed sodium cholate surfactant molecules. This is demonstrated in FIGS. 15c and 15d, which show that the mean graphene length and thickness are both linearly correlated (Pearson's R ˜0.9) with the graphene yield. The linear relationships between the graphene exfoliation rate and the flake size measurements in FIGS. 15e and 15f indicate that the physical size of the graphite/graphene flakes limits the rate at which it is exfoliated during ultrasonication. This finding demonstrates that inertial cavitation preferentially exfoliates larger flakes during ultrasonication. Such a size preference, likely arises from the increased size and or surface area of larger flakes, which absorb a greater fraction of the shockwave energy generated by nearby inertially cavitating bubbles. Larger graphite flakes will also have an increased probability of containing structural defects such as holes or tears, resulting in a greater fracturing potential. Furthermore, the length and thickness correlations with the ICD suggest that controlling inertial cavitation may allow for in-situ size control of the graphene size distribution during sonication. With further yield optimisation, the need for centrifugation may also be negated.

Graphene exfoliation is thus likely to be driven by a combination of jetting, microstreaming and shockwaves during sonication. As jetting is facilitated by nearby extended surfaces, and the maximum size of the graphite used (sieved to 45-75 μm) is much smaller than the resonant size of the cavitating bubbles found in this example (˜160 μm at 21.06 kHz), jetting events within the graphene dispersion will significantly decrease in frequency as the mean flake size decreases during sonication. However, jetting will continue to exfoliate any graphite/graphene flakes on the inner walls of the chamber. The local shear stresses generated by collapsing bubbles, known as microstreaming, are also unlikely to drive graphene exfoliation as the speed of microstreaming vortices is proportional to the squared frequency of cavitating bubbles, making microstreaming more effective at megasonic frequencies. Consequently, the shockwaves generated by inertial cavitation are the most probable exfoliation mechanism during sonication as produced by the method and apparatus disclosed herein. Shockwave exfoliation can be mediated by a combination of fracturing events triggered by incident shockwaves and the high velocity inter-particle collisions that are generated by incident shockwaves. However, as shockwaves lose more than 50% of their inertial energy over the first 25 μm of propagation due to absorption, and will be attenuated by dispersed graphene flakes (which will increase in density during sonication), graphene exfoliation is most likely facilitated by the shockwaves generated by immediately adjacent inertial cavitation collapse events.

It is also believed that inertial cavitation causes flake scission without introducing a significant number of basal plane defects in graphene during sonication.

Thus, by optimising the inertial cavitation dose, graphene yields of up to 18% have been produced. These high graphene yields, which are produced by ultrasonication, were achieved over relatively short sonication times with minimal temperature increases and low nominal input powers. The graphene yield as well as the graphene flake length and thickness exhibit a power law relationship with inertial cavitation dose, which is a direct measurement of the violent collapses that are indicative of inertial cavitation. During sonication, graphite is fractured in a multiplicative process by the shockwaves generated by immediately adjacent inertial cavitation activity.

### Example

For the sake of completeness, there is described below a specific example of a method and apparatus embodying the teachings herein. The skilled person will appreciate from the teachings herein that this is just one of many ways of implementing the invention.

Fine Flake Graphite purchased from Asbury Carbons was pre-treated by sonicating in a 1 litre LDPE container for 30 minutes in an Ultrawave IND1750 sonic bath at a concentration of 10 mg/ml, with 1 litre of 15 MΩ de-ionised water and 1 mg/ml of sodium cholate surfactant (Sigma Aldrich). The graphite was then vacuum dried and sieved through a 75 μm test sieve to remove large flakes and then sieved using a 45 μm test sieve to remove small flakes, resulting in a size distribution of 45-75 μm. 0.2 mg/ml of pre-treated and sieved graphite was added to a 28 ml LDPE Nalgene vial (Fisher Scientific) along with a 25 ml magnetically stirred solution of de-ionised water with 3 mg/ml of sodium cholate surfactant (Sigma Aldrich). The LDPE vials were pre-soaked in a water and surfactant solution (0.2% vol. of Cole Palmer MICRO-90) overnight prior to sonication to promote wetting of the external surface of the vials. The reference vessel was actively cooled using an array of 12 V fans when sonicating graphene samples over long durations. To facilitate cavitation, surfactant (Cole Palmer MICRO-90) was added at a 0.2% by-volume concentration to the bulk volume of the vessel. After sonication, the graphene dispersions were left to sediment overnight before being centrifuged at 1000 rpm (120 rcf) for 2 hours. The supernatant was then removed and characterised.

The method and apparatus taught herein can provide the following advantages and characteristics:

1) The size distribution of flakes produced can be tailored to the specific needs of a user's application. Batches of distinct size distributions can also be produced, allowing the user to explore the effect of different size distributions on their specific end application.

2) The method and apparatus can produce significantly higher yields than the industry (typically 1%), making the product cheaper.

3) The method and apparatus can negate the need for centrifugation, reducing production time, using less energy and making it less complicated.

4) The production rate of 2D materials can also be improved over competing methods.

5) Produced products can be more consistent between batches.

6) The method and apparatus can be used for a wide range of 2D materials, not just graphene.

The method and apparatus can be used for a variety of applications, including but not limited to:

a) the liquid phase exfoliation of 2D nanomaterials;

b) pharmaceutical applications such as DNA shearing;

c) crystallisation size control (pharma, foods);

d) aerospace (integration of 2D nanomaterials into CFRP and polymer composites);

e) automotive (integration of 2D nanomaterials into CFRP and polymer composites);

f) defence (integration of 2D nanomaterials into CFRP, polymer and ceramic composites);

g) energy generation (solar panels) and storage (batteries, supercapacitors, fuel cells);

h) medical applications (Graphene Quantum dots in drug delivery, imaging);

i) flexible/printed electronics (displays, sensors); and

j) computing (thermal management).

The method and apparatus disclosed herein can be used to process (exfoliate, fragment, crystallise, homogenise, react) many materials (such as polymers, particles, crystals, flakes, proteins, food etc.) in the liquid phase, and from industries varying from food production (100's of micrometres) to biofilm control (10's of nanometres), pharma API's and even DNA shearing. Some of these materials could be described as nanomaterials or micromaterials.

The disclosures in British patent application number 1812056.8, from which this application claims priority, and in the abstract accompanying this application are incorporated herein by reference.

1. A method of producing materials by exfoliation from a bulk material, including the steps of:
disposing bulk material in suspension in a liquid in a chamber;
applying superimposed ultrasound fields in the chamber, the superimposed ultrasound fields generating cavitation in the liquid at least at a zone of field superimposition;
measuring cavitation in the chamber while applying the superimposed cavitation fields, at least at the zone of field superimposition;
adjusting at least one of the ultrasound fields on the basis of measured cavitation so as to control the cavitation dose applied to the material and thereby to control exfoliation of the bulk material and the formation of materials therefrom.

2. A method according to claim 1, wherein the step of adjusting at least one of the ultrasound fields adjusts one or more of: acoustic pressure, time of application of the field or fields, ultrasound frequency and ultrasound amplitude distribution.

3. A method according to claim 1, wherein the step of measuring cavitation in the chamber measures inertial cavitation.

4. A method according to claim 1, including the step of controlling temperature of the liquid in the chamber during application of the superimposed ultrasound fields.

5. A method according to claim 1, including the step of circulating the liquid in the chamber during the application of the ultrasound fields.

6. A method according to claim 1, including the step of applying suspension energy to the liquid in the chamber for suspending bulk material in the zone of field superimposition.

7. A method according to claim 1, including the step of applying high intensity focused ultrasound to the chamber, said high intensity focused ultrasound imparting suspension energy to the liquid in the chamber for suspending bulk material in the zone of field superimposition.

8. A method according to claim 7, wherein the high intensity focused ultrasound is applied in a central zone of the chamber, allowing for toroidal movement of the suspension liquid in the chamber.

9. A method according to claim 1, wherein the superimposed ultrasound fields are produced by a plurality of transducers disposed so as to face into the chamber.

10. A method according to claim 1, wherein the superimposed ultrasound fields are produced by a plurality of transducers disposed in an annular arrangement facing into the chamber and wherein the chamber is at least partially cylindrical.

11. (canceled)

12. A method according to claim 1, for the production of at least one of: laminar elements from bulk material and graphene from graphite bulk material.

13. (canceled)

14. Apparatus for producing materials products by exfoliation from a bulk material, including:
a chamber for holding bulk material in suspension in a liquid;
an ultrasound generator unit including a plurality of ultrasound sources arranged around the chamber and operable to apply ultrasound fields in the chamber, said ultrasound fields being superimposed in a zone of field superimposition in the chamber;
a cavitation detector arranged to measure cavitation at least in the zone of field superimposition; and
a control unit coupled to the ultrasound generator and to the cavitation detector, and configured to adjust at least one of the ultrasound fields on the basis of measured cavitation, so as to control the cavitation dose applied to the material, thereby to control exfoliation of the bulk material and the formation of materials therefrom.

15. Apparatus according to claim 14, wherein the control unit is configured to adjust one or more of: field intensity, time of application of the field or fields, ultrasound frequency and ultrasound amplitude.

16. Apparatus according to claim 14, wherein the cavitation detector is configured to measure inertial cavitation.

17. Apparatus according to claim 14, including at least one of:
a temperature control device for controlling temperature of the liquid in the chamber.

18. Apparatus according to claim 14, including at least one of:
a fluid circulation element operable to circulate liquid in the chamber during the application of the ultrasound fields; and
a fluid suspension device configured to apply suspension energy to the liquid in the chamber for suspending bulk material in the zone of field superimposition.

19. (canceled)

20. Apparatus according to claim 14, including a high intensity focused ultrasound generator configured to apply high intensity focused ultrasound in the chamber so as to impart suspension energy to liquid in the chamber for suspending bulk material in the zone of field superimposition, wherein the high energy focused ultrasound generator extends over a part of a lateral dimension of the chamber, so as to apply high energy focused ultrasound in a central zone of the chamber, allowing for toroidal movement of the suspension liquid in the chamber.

21. (canceled)

22. (canceled)

23. Apparatus according to claim 14, wherein the ultrasound generator unit is an annular arrangement of transducers disposed facing into the chamber and the chamber is at least partially cylindrical.

24. (canceled)

25. Apparatus for producing materials products by exfoliation from a bulk material, including:
a chamber for holding bulk material in suspension in a liquid;
an ultrasound generator unit including a plurality of ultrasound sources arranged around the chamber and operable to apply ultrasound fields in the chamber, said ultrasound fields being superimposed in a zone of field superimposition in the chamber;
a high intensity focused ultrasound generator configured to apply high intensity focused ultrasound in the chamber so as to impart suspension energy to liquid in the chamber for suspending bulk material in the zone of field superimposition;
whereby the ultrasound fields are operable to generate cavitation energy at least in the zone of field superimposition thereby to subject bulk material to exfoliation for the formation of materials therefrom.

26. Apparatus according to claim 25, wherein the high intensity focused ultrasound generator is operable to circulate liquid in the chamber during the application of the ultrasound fields.

27. Apparatus according to claim 25, including a cavitation detector arranged to measure cavitation at least in the zone of field superimposition; and
a control unit coupled to the ultrasound generator and configured to adjust at least one of the ultrasound fields on the basis of measured cavitation so as to control cavitation energy applied to the material, thereby to control exfoliation of the bulk material and the formation of materials therefrom.

28. Apparatus according to claim 27, wherein the control unit is configured to adjust one or more of: field intensity, time of application of the field or fields, ultrasound frequency and ultrasound amplitude.
